(19) United States
(12) Patent Application Publication
(10) Pub. No.: US 2023/0296487 A1
(43) Pub. Date: Sep. 21, 2023

(54) WEARABLE INTEGRATED PARTICULATE SENSOR DEVICE

(71) Applicant: X Development LLC, Mountain View, CA (US)

(72) Inventor: Samuel Khamis, San Francisco, CA (US)

(21) Appl. No.: 17/698,709

(22) Filed: Mar. 18, 2022

(51) Int. Cl. G01N 15/06; G08B 21/18

(52) U.S. Cl. CPC G01N 15/0656; G08B 21/18

(57) ABSTRACT

A wearable particulate sensor device including multiple conductive gratings, each of the conductive gratings including a respective pore size of multiple different pore sizes, a control unit in electrical communication with the conductive gratings, and a housing aligning the conductive gratings with respect to an airflow path when the wearable particulate sensor device is affixed to a wearable device, and where a respective resistivity of one or more of the conductive gratings changes in response to a presence of a threshold concentration of a particulate in the airflow path.

### TECHNICAL FIELD

This specification relates to wearable particulate sensor devices.

### BACKGROUND

Wearable smart devices are smart electronic devices that are worn by a user and can be utilized to track various signals to extract user habits and health-related information, e.g., heart rate, activity levels, location, sleep patterns, etc. Capturing health statistics can be useful for data driven analysis for monitoring and responding to health conditions of individual users as well as a larger population of users.

### SUMMARY

The technology of this patent application relates to a wearable particulate sensor device. More particularly, the technology uses a sensor including an array of conductive gratings having a range of different, well-defined pore sizes corresponding a range of expected diameters of various allergen particulates (e.g., different pollens, molds, spores, etc.). When an allergen of a particular average size encounters the array of conductive gratings, it can pass through gratings having a pore size larger than a diameter of the allergen and adhere to the gratings having a pore size on the same order as and smaller than the average diameter of the allergen. When the allergen adheres to one or more of the conductive gratings of the array, sensor data including a resistivity of the one or more mesh gratings changes in response. A control unit in electrical contact (i.e., in electrical communication) with each of the conductive gratings can measure a change in resistance across one or more of the conductive gratings of the array. Sensor data can additionally include a current temperature/humidity of the air surrounding the smart device.

The sensor can be integrated into a smart device, for example, the sensor can be integrated/embedded into a watch band of a smart watch. In another example, the sensor can be integrated into a protective case or peripheral of a mobile phone or tablet device. The sensor can be arranged such that air surrounding the smart device can flow through (e.g., perpendicular to) the array of conductive gratings, for example, a profile of the sensor can be embedded in a watch band (e.g., a flip-out design to expose air to the sensor or a low profile slot within the watch band to flow air across the sensor as the user moves their arm with the smart watch). The control unit of the sensor can be in data communication with the smart device, e.g., via Bluetooth, Zigbee, etc., where some or all of the processing of the sensor data can be performed by an application on the smart device.

An allergen detection model can be trained using training data including resistivity changes in the sensor in response to particulates of known size distributions and/or concentrations under varying temperature/humidity conditions. Additionally, the allergen detection model can be trained to account for changes in responsivity of the sensor over a lifetime of the sensor, in other words, how the resistance of the sensor in response to an allergen changes as the sensor ages (e.g., as it collects particulates on the surface of the sensor). The allergen detection model can be trained to detect when the sensor has reached an estimated lifetime of the sensor and required changing. The trained allergen detection model can receive a resistivity change signal from a sensor and determine a range of sizes (or average size) and/or concentration of allergen particulates that are present in the air surrounding the sensor.

In general, one innovative aspect of the subject matter described in this specification can be embodied in a wearable particulate sensor device including multiple conductive gratings, each of the conductive gratings including a respective pore size of multiple different pore sizes, a control unit in electrical communication with the conductive gratings, and a housing aligning the conductive gratings with respect to an airflow path when the wearable particulate sensor device is affixed to a wearable device, and where a respective resistivity of one or more of the conductive gratings changes in response to a presence of a threshold concentration of a particulate in the airflow path.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, in response to the presence of the particulate in the airflow path, the respective resistivity of the one or more conductive gratings changes by a first amount, and in response to a presence of a second, different particulate in the airflow path, the respective resistivity of the one or more conductive gratings changes by a second amount different from the first amount.

In some implementations, one or more of the multiple conductive gratings includes a conductive wire mesh including one or more of nanowires, carbon nanotubes, and bulk wires. In some implementations, one or more of the multiple conductive gratings includes a SiN membrane.

In some implementations, the control unit is in data communication with one or more smart devices via a wireless data communication link. The wearable device can be a smart watch, where the housing can be embedded in a watch band of the smart watch.

In some implementations, the multiple conductive gratings include a first conductive grating having a first pore size of the multiple different pore sizes and a second conductive grating having a second, different pore size of the multiple different pore sizes.

In some implementations, the control unit is configured to detect the respective resistivity of one or more of the multiple conductive gratings changing in response to a presence of a threshold concentration of a particulate in the airflow path.

In general, another innovative aspect of the subject matter described in this specification can be embodied in methods for training a machine-learned particulate prediction model including: generating training data for multiple known particulates in an environment including: providing multiple conductive gratings, wherein each of the multiple conductive gratings includes a respective pore size of multiple different pore sizes, providing, to the multiple conductive gratings and incident on respective surfaces of the multiple conductive gratings, multiple known concentrations of the multiple known particulates. For each known concentration of the multiple known concentrations of a known particulate of the multiple known particulates: providing, to the multiple conductive gratings and incident on respective surfaces of the multiple conductive gratings, the known concentration of the known particulate, and collecting, by a data processing apparatus, data generated by the multiple conductive gratings in response to the known concentration of the known particulate, and providing, to the particulate prediction model, the training data.

The foregoing and other embodiments can each optionally include one or more of the following features, alone or in combination. In particular, one embodiment includes all the following features in combination.

In some implementations, the data generated by the multiple conductive gratings includes a change in a respective resistivity of one or more of the multiple conductive gratings in response to a presence of a threshold concentration of the known particulate.

In some implementations, the methods further include receiving, by the machine-learned particulate prediction model, data generated by a conductive grating indicative of a detection of an unknown particulate by the conductive grating in an airflow path incident on the conductive grating, generating, by the machine-learned particulate prediction model, a prediction including a size of the unknown particulate detected by the conductive grating; and providing, by the machine-learned particulate prediction model, the prediction including the size of the unknown particulate detected by the conductive grating.

In some implementations, receiving data generated by the conductive grating indicative of the detection of the unknown particulate includes receiving an input voltage signal from the conductive grating.

In some implementations, the prediction further includes a prediction of a concentration of the unknown particulate detected by the conductive grating.

In some implementations, the methods further include determining, based on the prediction including the size of the unknown particulate, an allergen in the airflow path, generating an alert including information about the allergen, and providing the alert to a user. The alert can include information about a concentration of the allergen.

In some implementations, determining the allergen in the airflow path includes comparing the size of the unknown particulate to a lookup table of pollen sizes to identify the allergen, and/or providing, to a neural network, the prediction including the size of the unknown particulate, and receiving, from the neural network, the allergen in the airflow path.

In some implementations, generating training data for the plurality of known particulates in the environment further includes providing, to the multiple conductive gratings and incident on respective surfaces of the multiple conductive gratings, and for each of the multiple known concentrations of the multiple known particulates, the known concentration of the known particulate over a range of time corresponding to respective changes in sensitivity of the multiple conductive gratings over the range of time, and collecting, by the data processing apparatus, data generated the plurality of conductive gratings in response to the known concentration of the known particulate over the range of time, and providing, to a machine-learned particulate prediction model, the training data.

In some implementations, the methods further include receiving, by the machine-learned particulate prediction model, data generated by a conductive grating of the multiple conductive gratings indicative of a detection of a given particulate by the conductive grating, generating, by the machine-learned particulate prediction model, a prediction of an estimated lifetime of the conductive grating, and providing, by the machine-learned particulate prediction model, the prediction including the estimated lifetime of the conductive grating.

The subject matter described in this specification can be implemented in particular embodiments so as to realize one or more of the following advantages. An advantage of this technology is that it can be integrated as a low-profile peripheral in a smart wearable device and provide local, real-time feedback to a user of the presence of allergens in an area surrounding the user. An output of a system including the sensor can be a notification to a user of the detected presence of a particular allergen (e.g., “Juniper pollen levels are high in your area”). The system can track the presence of allergens surrounding the user over time which can be used to determine exposure levels over a period of time, identify particular allergen-sensitivities, and the like.

Other applications of this technology include, for example, particulate detectors in filtration systems (e.g., HVAC systems, stand-alone air purifiers), face-masks, and respirators (i.e., to determine exposure levels/know when it is time to change filters).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A depicts an example operating environment for a wearable integrated particulate sensor device.

FIG. 1B depicts schematic views an example wearable integrated particulate sensor device integrated into a smart watch.

FIG. 1C depicts schematic views of another example wearable integrated particulate sensor device integrated into a smart watch.

FIG. 2 depicts an example schematic of a conductive grating according to some embodiments.

FIG. 3 depicts an example schematic of a particulate sensor device according to some embodiments.

FIG. 4 depicts an example schematic of a particulate sensor device according to some embodiments.

FIG. 5A is a flow diagram of an example process for a wearable integrated particulate sensor device.

FIG. 5B is a flow diagram of another example process for a wearable integrated particulate sensor device.

FIG. 6 is a block diagram of an example computer system.

Like reference numbers and designations in the various drawings indicate like elements.

### DETAILED DESCRIPTION

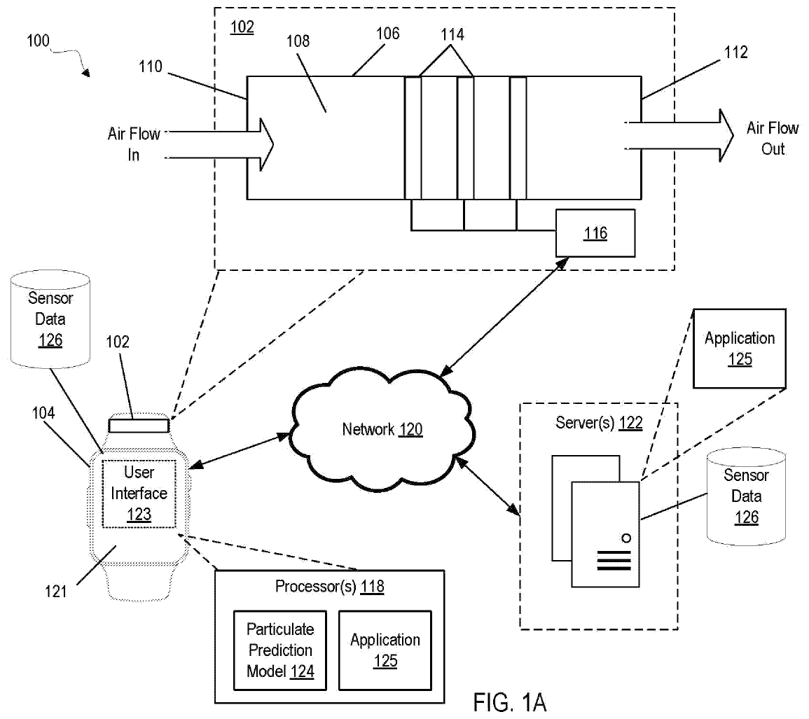

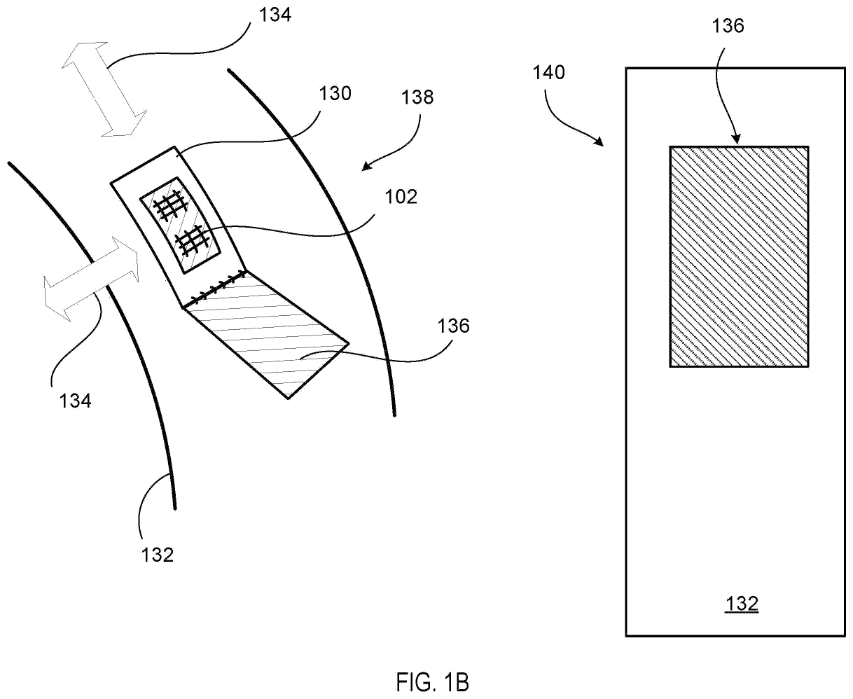

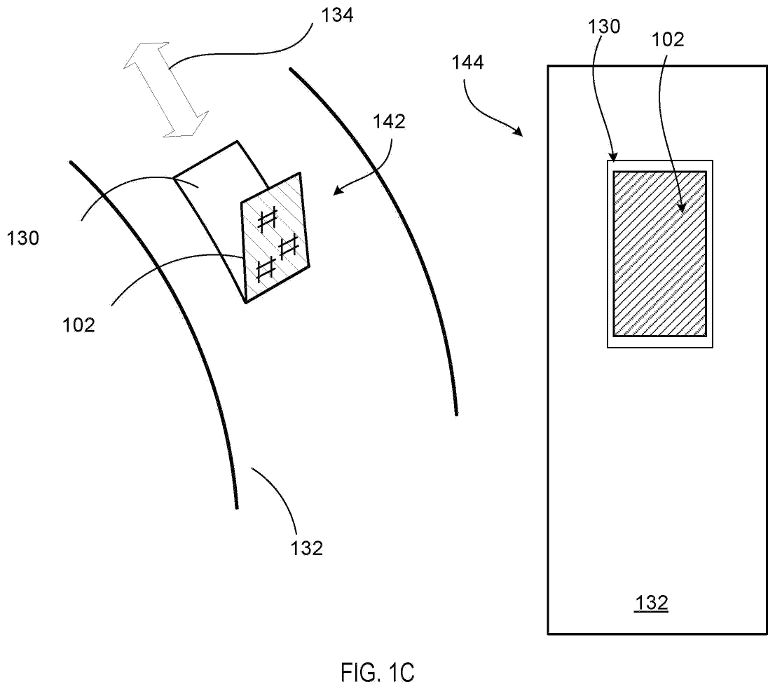

FIG. 1A depicts an example operating environment 100 for a wearable integrated particulate sensor device 102. The particulate sensor device 102 can be integrated into a wearable smart device 104, e.g., a smart watch. As depicted in FIG. 1A, the particulate sensor device 102 is integrated into a watch band of a smart watch. In some implementations, the particulate sensor device 102 can be a standalone device, e.g., on a FOB or keychain. In some implementations, the particulate sensor device 102 can be integrated into a peripheral for a smart device, e.g., into a case for a smart phone or tablet.

In some implementations, the particular sensor device 102 can be integrated into a wearable article of clothing, e.g., personal protective equipment (PPE). For example, a face mask, respirator, googles, hardhat, a Tyvek suit, or the like.

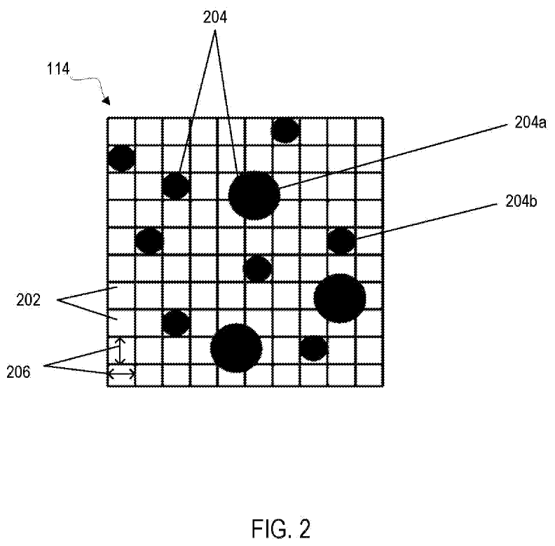

Particulate sensor device 102 includes a housing 106 enclosing an inner volume 108 and including an inlet 110 and outlet 112 to allow a flow of air through the housing 106. Particulate sensor device 102 includes one or more conductive gratings 114, which can be, as depicted in FIG. 1A, arranged perpendicular to a flow of air with respect to the housing 106 of the particulate sensor device 102. Conductive grating(s) 114 are in data communication with a control unit 116, where the control unit 116 is configured to measure a voltage signal, e.g., a voltage difference across the conductive grating(s) 114. Control unit 116 can be configured to detect the respective resistivity of one or more of the conductive gratings 114 changing in response to a presence of a threshold concentration of a particulate in the airflow path. Further details of the conductive grating(s) 114 is discussed with reference to FIGS. 2-4 below.

The control unit 116 can be in data communication with one or more processors 118 of the smart device 104, e.g., via a wireless data communication link (Bluetooth, Wi-Fi, Zigbee, etc.), over a network 120. In some implementations, some or all of the processes described herein can be performed by the one or more processors of the smart device 104.

In some implementations, control unit 116 can be in data communication with one or more cloud-based servers 122 over the network 120, e.g., via a wireless data communication link. Some or all of the processes described herein can be performed by the one or more cloud-based servers 122 in data communication with the control unit 116.

Smart device 104, e.g., a smart watch, can include a display 121. A user of the smart device 104 may interact with the particulate sensor device 102 via a graphical user interface (GUI) 123 of an application 125 presented on the display 121 of the smart device 104. In some implementations, a user may interact with the particulate sensor device 102 via a user interface (e.g., an application environment) of an application presented on a different device, e.g., on a computer, mobile phone, etc. that is in data communication with particulate sensor device 102 via network 120.

In some implementations, application 125 can be hosted on one or more cloud-based servers 122, e.g., a web-based application. A user may access the application 125 via the network 120.

In some implementations, housing 106 of the particulate sensor device 102 can be affixed and arranged with respect to the smart device 104 (e.g., smart watch) such that a profile of the particulate sensor device 102 is embedded in the watch band. For example, as depicted in FIG. 1B, the particulate sensor device 102 can be embedded in a low profile recess 130 in a watch band 132 of a smart watch, such that air flow 134 across the watch band 132 is captured by particulate sensor device 102 as the user moves their arm. The particulate sensor device 102 can be oriented such that air flow 134 is incident on conductive grating(s) within the particulate sensor device 102, e.g., perpendicular to a length of the watch band 132 or parallel to the length of the watch band 132. A cover 136 fitted over the recess 130 can serve to protect the particulate sensor device 102 and/or to selectively expose the particulate sensor device 102 to air flow 134. Cover 136 can be affixed to the watch band 132 by a hinge or another fixture that allows the cover 136 to be in a first open position 138 and a second closed position 140.

In another example, as depicted in FIG. 1C, the particulate sensor device 102 can include a flip-out design to expose air flow 134 across the conductive grating(s) 114. Though the particulate sensor device 102 is depicted in FIG. 1C as oriented on the watch band 132 such that air flow 134 is parallel to the length of the watch band, other orientations are contemplated. The particulate sensor device 102 can be affixed to the watch band 132 by a hinge or another fixture that allows the particulate sensor device 102 to be in a first position 142 (“flipped-out”) and a second position 144. First position 142 can be utilized to position the sensor device 102 in the air flow 134 to collect data, and second 144 can be utilized to protect the sensor device 102 when not in active use. In second position 144, the sensor device 102 can be embedded in a low profile recess 130 in watch band 132 of a smart watch.

In some implementations, sensor data 126 can be collected with different concentrations of the allergens of interest present in the air flow incident on the conductive grating. Sensor data 126 can be collected at different points of a life-cycle of the conductive grating(s) 114, e.g., as the conductive grating ages and may become less sensitive to particulates. In some implementations, sensor data 126 is a resistance change for a respective conductive grating 114 of the particulate sensor device 102 collected by control unit 116.

In some implementations, sensor data 126 can be collected for particulate sensor devices 102 that are subjected to different external vibrations, e.g., different movements of one or more users wearing smart devices 104 including the embedded particulate sensor device 102. In other words, the particulate prediction model can be trained to account for variations in AC signals caused by user-induced or environmental vibrations.

In some implementations, sensor data 126 can be collected for particulate sensor devices 102 having different inner volumes 108 of the housing 106, e.g., to account for different volume cavities and associated vibrational damping of signals and/or to account for different volumes of airflow across the conductive gratings 114.

In some implementations, sensor data 126 can be collected for particulate sensor devices 102 having different numbers and configurations of conductive gratings 114. Training the particulate prediction model can include learning how measurements generated by various configurations of conductive gratings 114 in the particulate sensor device 102 relates to concentration and particulate size.

In some implementations, a repository of sensor data 126 collected by multiple different particulate sensor devices 102 can be stored on a cloud-based server 122 and utilized to train a particulate prediction model 124.

A particulate prediction model 124 can be trained using sensor data 126 collected by the particulate sensor device 102 to perform predictions based on the data collected of the particulate sensor device 102. The particulate prediction model 124 can be a federated learning model, or another model that can facilitate learning a shared prediction model while keeping training data unique to the user on the user's device. One or more classifiers can be utilized in the particulate prediction model 124 to identify sizes and/or types of particulates. Sensor data 126 collected by the particular sensor device 102 can be stored locally on smart device 102, on one or more cloud-based servers 122, and/or a combination thereof. Generation and training the particulate prediction model 124 can be performed on one or more cloud-based servers 122, on one or more processors 118 of the smart device 104, or a combination thereof.

In some implementations, training of the particulate prediction model 124 can be performed utilizing sensor data 126 collected for multiple allergens of varying size ranges (e.g., diameter ranges, physical characteristics, etc.) using multiple conductive gratings 114. Sensor data 126 can be collected under differing environmental conditions (e.g., different humidity, temperature, air flow rates, barometric pressure, etc.) and/or in different geographic locations to generate a robust model.

In some implementations, a local refinement of the particulate prediction model 124 can be performed on the one or more processors 118 of the smart device 104, e.g., can be performed to refine the particulate prediction model 124 based on environmental factors for a particular user. Once trained, the particulate prediction model 124 can receive sensor data 126 from the particulate sensor device 102 as input and provide a prediction of a size or average size of particulate present on the conductive grating 114 of the particulate sensor device 102 as output.

In some implementations, an output of the particulate prediction model 124 can be compared to a look-up table (LUT) of allergen particulate sizes (or average sizes) to identify one or more candidate allergens present in the air flow through the particulate sensor device. For example, application 125 can receive the output of the particulate prediction model 124 and compare the output (e.g., a particulate size) to a LUT to determine one or more candidate allergens present in the air flow through the particular sensor device 102.

In some implementations, the output of the particulate prediction model can be provided to a second neural network trained to correlate the prediction of size or average size of particulate with a potential allergen(s) present in the air flow through the particulate sensor device

Information related to the detected particulates, e.g., allergen(s), present in the air flow through the particulate sensor device can be provided for presentation to a user in the user interface 123 (e.g., an application environment) on a display 121 of the smart device 104. For example, “a concentration X of allergen A is detected in the air around you.”

In some implementations, information related to the detected allergen(s) present in the air flow through the particulate sensor device 102 can be provided as an alert (e.g., a pop-up alert, SMS/text, etc.) via the display 121 of the smart device 104.

In some implementations, the detected allergen(s) present in the air flow through the particulate sensor device 102 can be collected, e.g., by a cloud-based server 122, for long-term monitoring. In one example, sensor data 126 related to detected allergen(s) present can be utilized to help a user identify particular allergens (e.g., pollens, spores/mold) to which they are allergic/sensitive.

In some implementations, long-term monitoring can be utilized to alert a user to acute or chronic exposure levels to particulates, e.g., for workplace/OSHA compliance, to alert the user to change out a filter in an HVAC system, to alert the user to change out a filter on a respirator or other PPE, etc.

FIG. 2 depicts an example schematic of a conductive grating 114 according to some embodiments. As described above with reference to FIG. 1A, a particulate sensor device 102 includes one or more conductive gratings 114 including conductive meshes and/or conductive membranes.

A pore size of pores 202 of a conductive grating 114 can be selected to interact (i.e., capture) particulates 204 of a range of diameters of interest. In other words, a pore size of pores 202 of a conductive grating 114 can be selected based on a type of allergen (e.g., a pollen, mold spore, dust, etc.) of interest. In one example, a pore size 206 can be defined as a cross-sectional area defined between wires of a wire mesh. In another example, a pore size 206 can be defined by one or more dimensions (e.g., diameter) of an opening in the conductive membrane.

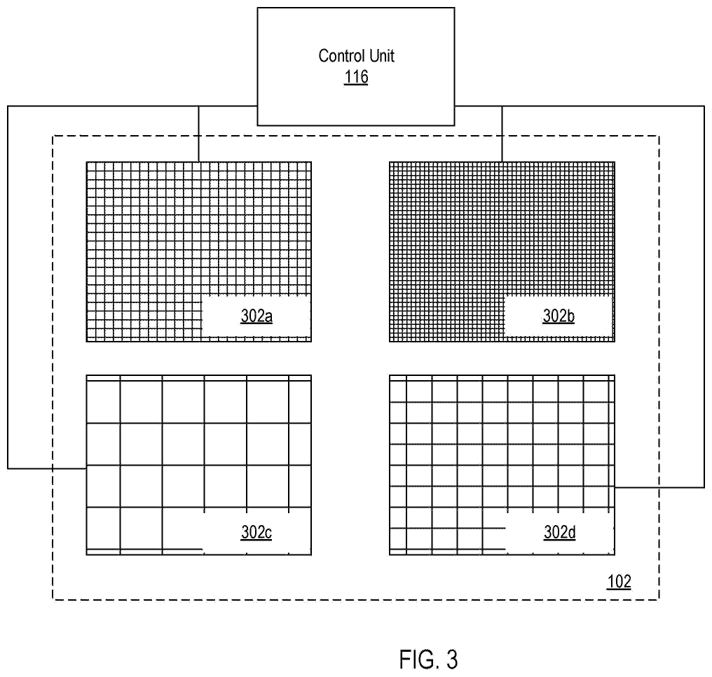

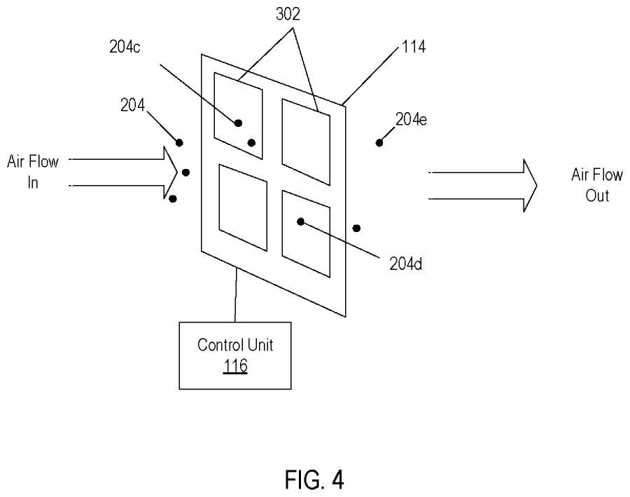

In some implementations, a conductive grating 114 can include two or more sensing regions each having a respective pore size of pores. Further details of sensing regions of a conductive grating 114 are described below with reference to FIGS. 3 and 4.

As depicted in FIG. 2, a conductive grating 114 can capture/interact with particulates 204 of interest, e.g., allergen 204a of a first range of diameters and/or allergen 204b of a second range of diameters, in the air flow through the inner volume of the particulate sensor device as they pass across the conductive grating. As particulates 204 are captured/interact with the conductive grating 114, (e.g., contact the conductive mesh or conductive membrane) a change in voltage signal is measured by the control unit (e.g., control unit 116 of FIG. 1A), i.e., a resistance change is detectable due to the interaction of the particulate with the conductive grating. Different sized particulates 204 interacting with the conductive grating 114 can generate different resistance measurements.

In some implementations, a particulate sensor device 102 can include a suspended SiN membrane supported by a silicon substrate, where a conductive film (e.g., nanowires, nanotube, metallic mesh, conductive ceramic, a 2D material etched into the mesh shape) is deposited on a surface of the SiN membrane. Wire diameter and composition of the conductive grating can be selected such that a portion of conduction occurs on a surface of the conductive grating. In response to a particulate on the same order size comes into contact with a surface of the conductive grating 114, a resistance change can be measured across the conductive mesh.

In some implementations, a sensitivity of the particulate sensor device 102 can be selected by a type of wire diameter and composition utilized in the conductive grating 114. For example, conductive grating 114 can include nanowires such that 5-10× change in resistance is measured when a particulate 204 interacts with the conductive grating 114. In another example, nanotubes can be utilized to achieve on the order of a few orders of magnitude change in resistance. In another example, conductive grating can include bulk wire, e.g., 40 gauge wire, between 40 and 18 gauge wire, smaller than 18 gauge wire, etc., such that a small change in current (e.g., ˜1 microA-100 nA change) can be measured.

In some implementations, different types of conductive gratings 114 can be incorporated into a particulate sensor device 102. For example, the particulate sensor device 102 can include conductive gratings of a first type (e.g., nanowire-based sensor) and a second, different type (e.g., bulk-wire-based sensor). The different types of conductive gratings 114 can be arranged in a “stacked” configuration, where air flow through the device passes sequentially through (i.e., is incident upon) each conductive grating 114, e.g., as depicted in FIG. 1A.

In some implementations, conductive gratings 114 with different respective pore sizes 206 can be incorporated in a particulate sensor device 102. The different types of conductive gratings 114 can be arranged in a “stacked” configuration, where air flow through the device passes sequentially through (i.e., is incident upon) each conductive grating 114, where airflow is incident on a conductive grating having a larger pore size and subsequently incident on a conductive grating having a smaller pore size.

FIG. 3 depicts an example cross-sectional schematic of a particulate sensor device 102 according to some embodiments. In some implementations, as depicted in FIG. 3, a particulate sensor device 102 includes a conductive grating 114 which can include two or more sensing regions having different pore sizes. In some implementations, a particulate sensor device 102 includes at least one conductive grating 114 including two or more sensing regions having different conductive mesh pore sizes.

As depicted in FIG. 3, in some implementations a particulate sensor device 102 includes a conductive grating 114 having multiple sensing regions, e.g., 302a, 302b, 302c, and 302d, each sensing region of the conductive grating having a respective pore size 202. In some implementations, the respective sensing regions 302a-d can have a different respective pore size 202. In some implementations, some or all of the respective sensing regions 302a-d can have a same respective pore size 202. In some implementations, two or more of the multiple sensing regions of conductive grating 114 can have a same range of pore sizes. As described above, a size range of the multiple conductive gratings 114 can be selected based on different ranges of particle sizes for particulates 204 measured as different resistance measurements. Each of the sensing regions 302a-d of the conductive gratings 114 are electrically connected to the control unit 116 such that the control unit 116 can detect a change in resistance across each of the conductive gratings (e.g., as a voltage signal).

Though depicted with reference to FIG. 3 as a conductive grating including four sensing regions of conductive mesh having a same cross-sectional area, a conductive grating can include more or fewer sensing regions of conductive mesh and which can be of a same or different cross-sectional areas.

FIG. 4 depicts an example schematic of a particulate sensor device according to some embodiments. Air flow past a conductive grating, e.g., conductive grating 114, of a particulate sensor device, e.g., particulate sensor device 102, is depicted schematically with reference to FIG. 4. As depicted in FIG. 4, particulates 204 (e.g., allergens) present in the air flow incident on the conductive grating 114 of a particulate sensor device 102 including multiple sensing regions 302 can be trapped by one or more of the sensing regions 302, e.g., conductive mesh areas having pore sizes, e.g., pore sizes 202, on the order or smaller than the allergen diameter size, and may pass through conductive mesh areas having pore sizes larger than (i.e., substantially larger than) the diameter range of the allergen.

In some implementations, different sensing regions 302 of a conductive grating 114 can interact with different sets of allergens present within the air flowing past the particulate sensor device 102. For example, a first particulate 204c (e.g., Allergen A) can be trapped by mesh pore size 1 and a second particulate 204d (e.g., Allergen B) can be trapped by mesh pore size 2. A third particulate 204e, (e.g., Allergen C) may pass through without being captured by any of the sensing regions 302 of the conductive grating 114 (e.g., an allergen not of interest).

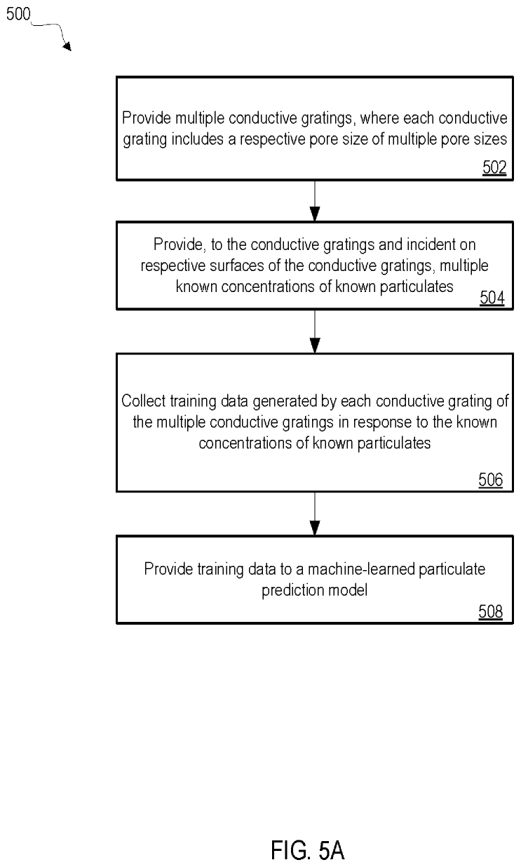

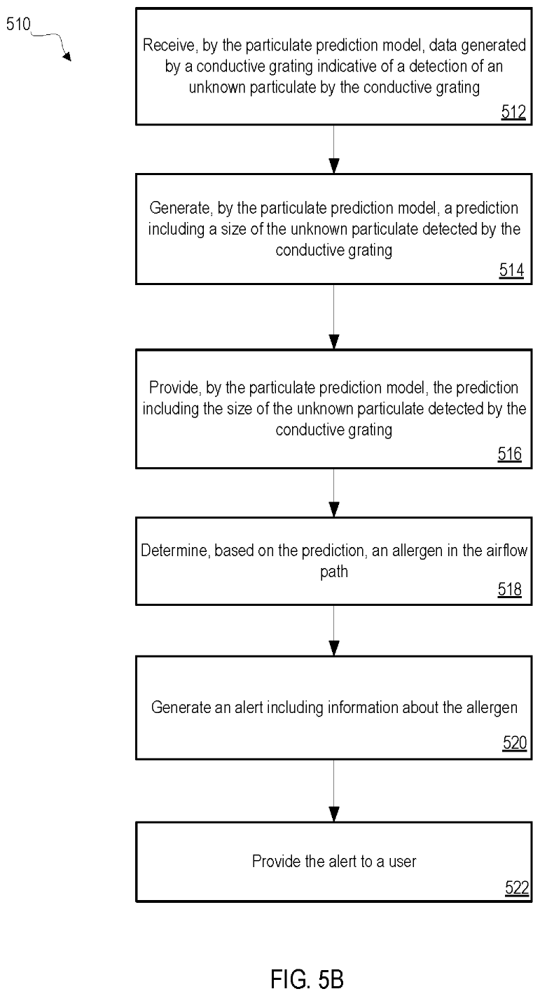

FIG. 5A is a flow diagram of an example process for a wearable integrated particulate sensor device. Process 500 describes generating training data for multiple known particulates in an environment to train a particulate prediction model, according to some embodiments. One or more of the processes described with reference to process 500 can be performed by server(s) 122, or another data processing apparatus. In the environment (e.g., a controlled lab environment), provide multiple conductive gratings where each conductive grating includes a respective pore size of multiple pore sizes (502). The multiple conductive gratings, e.g., conductive gratings 114, can be provided as a part of a particulate sensor device 102, e.g., as depicted in FIG. 1A. In some implementations, the multiple conductive gratings can be stand-alone during the collection of training data. The multiple conductive gratings 114 can include multiple different pore sizes of respective pores, and can include different materials systems and/or different types of conductive gratings (e.g., conductive mesh, nanowires, nanotubes, etc.). The multiple conductive gratings 114 can be selected to be sensitive to a subset of particulates of interest, e.g., with pore size ranges corresponding to average sizes of the subset of particulates of the interest.

Provide multiple known concentrations of known particulates to the conductive gratings and incident on the respective surfaces of the conductive gratings (504). Known particulates, e.g., pollens, molds, spores, etc., can be provided in known concentrations in an airflow incident on the conductive gratings 114. In some implementations, known particulates are provided in the airflow to an inlet 110 of a particulate sensor device 102 including conductive grating(s) 114. In some implementations, a chemical distribution system including, for example, flow regulators, valves, tubing, and gas sources including the particulates dispersed in gas (e.g., in ambient air, nitrogen, etc.) can be utilized to provide the multiple known concentrations of known particulates to the conductive gratings.

Collecting, by the server(s) 122, training data generated by each conductive grating of the multiple conductive gratings in response to the known concentrations of known particulates (506). Data, e.g., voltage signal, resistivity measurements, etc., can be collected by control unit 116 in data communication with the conductive gratings 114. Training data can include changes in voltage signal for a conductive grating in response to exposure to a known particulate of a known concentration.

In some implementations, training data is collected for known particulates of known concentrations over a period of time, e.g., a portion of a lifetime of the conductive grating 114. In other words, training data is collected to be robust to aging of the conductive grating in response to repeat exposure to particulates. Training data can include timestamps referencing an age and/or number of exposures to airflow containing particulates of the conductive grating.

Training data, e.g., sensor data 126, can be collected and stored by one or more servers 122 via the network 120. Sensor data 126 can be collected and stored locally on a smart device 104. In some implementations, a smart device 104 collects training data to refine the particulate prediction model in response to a particular environment of the user of the smart device 104 including the particulate sensor device 102.

Providing, by the server(s) 122, the training data to a machine-learned particulate prediction model (508). The trained machine-learned particulate prediction model can be utilized to generate predictions of particulate size and concentration, for example, as described in process 510 of FIG. 5B.

FIG. 5B is a flow diagram of another example process for a wearable integrated particulate sensor device. Process 510 describes utilizing a trained particulate prediction model to provide a prediction including a size of the unknown particulate detected by a conductive grating, according to some embodiments.

A particulate prediction model receives data generated by a conductive grating indicative of a detection of an unknown particulate by the conductive grating (512). Data generated by the conductive grating, e.g., conductive grating 114 of a particulate sensor device 102 integrated with a smart device 104, can include, for example, a change in voltage signal collected by a control until 116 in response to the unknown particulate contacting the conductive grating 114. In some implementations, data includes multiple respective changes in voltage signal collected by the control unit for multiple conductive gratings located within the volume 108 of a particulate sensor device 104.

In some implementations, data includes a timestamp and/or information relating to an age or number of exposures of the conductive grating 114 that has generated the data. For example, the data can include information detailing that the conductive grating is operating at 50% capacity. In another example, the data can include information detailing that the conductive grating is 2 years old. In another example, that data can include information detailing that the conductive grating has been exposed 200 times since installation.

The particulate prediction model generates a prediction including a size of the unknown particulate detected by the conductive grating (514). The particulate prediction model receives the collected data as input and provides a prediction including a size (e.g., a diameter or another physical characterization) of the unknown particulate as output. In some implementations, the prediction includes a concentration of the unknown particulate.

In some implementations, the prediction includes a range of sizes of the unknown particulate and can further include a range of concentrations of the unknown particulate in the air flow incident on the conductive grating 114.

In some implementations, the prediction includes a determination to clean the particulate sensor device or replace some or all of the parts of the particulate sensor device 102.

The particulate prediction model provides the prediction including the size of the unknown particulate detected by the conductive grating (516). In some implementations, prediction from the particulate prediction model is provided to a secondary neural network. The secondary neural network can be hosted on a cloud-based server 122 and in data communication with the particular sensor device 102 via the network 120. In some implementations, the secondary neural network can be locally stored on processors 118.

In some implementations, the output of the particulate prediction model can be provided to a look-up table (LUT) to compare the prediction of a size of the unknown particulate with a list of known allergens having known sizes. In some implementations, a LUT can be located on the one or more servers 122 and/or on the smart device 102.

Determine, an allergen in the airflow path, based on the prediction (518). In some implementations, the secondary neural network can receive the prediction as input and provide a prediction including one or more candidate allergens and a respective confidence scores as output. For example, the secondary neural network can receive a size range of the particulate and provide a list of likely candidate allergens as output.

In some implementations, processors(s) 118 can perform a comparison of the output of the particulate prediction model 124 to the LUT. In some implementations, a cloud-based application 125 can perform the comparison between the size prediction output of the particulate prediction model and the LUT.

Generate an alert including information about the allergen (520). In some implementations, application 125 can generate an alert from the information about the allergen. In some implementations, the alert may include information related to long-term monitoring of the allergen and/or a user's medical history with the allergen. For example, the alert can include information about a pollen concentration present in the environment around the user and the user's allergy to the pollen (“Ragweed is high in your area, remember to take your allergy medication!”).

In some implementations, the alert includes information related to an estimated lifetime of the sensor device 102 including one or more conductive gratings 114. The alert can include information related to replacing the sensor device 102 or conductive gratings 114 in response to a determination that the conductive gratings 114 are performing below a threshold responsivity. For example, an alert can include a message “Your sensor is at 10% performance value, it needs to be replaced!”

Provide the alert to a user (522). The alert can be provided via one or more services including, for example, as a pop-up alert, SMS/text, etc. via the display 121 of the smart device 104.

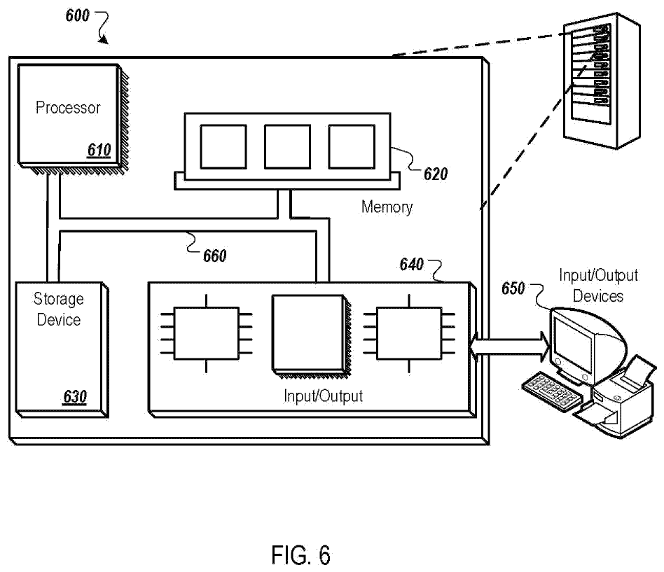

FIG. 6 is block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 660. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 302.11 card. In another implementation, the input/output device can include driver devices configured to receive input data and send output data to other input/output devices, for example, keyboard, printer and display devices 650. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, that is, one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, for example, an FPGA (field programmable gate array) or an ASIC (application-specific integrated circuit). The apparatus can optionally include, in addition to hardware, code that creates an execution environment for computer programs, for example, code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, for example, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device, for example, a universal serial bus (USB) flash drive, to name just a few.

Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, for example, a smartphone that is running a messaging application, and receiving responsive messages from the user in return.

Data processing apparatus for implementing machine learning models can also include, for example, special-purpose hardware accelerator units for processing common and compute-intensive parts of machine learning training or production, that is, inference, workloads.

Machine learning models can be implemented and deployed using a machine learning framework, for example, a TensorFlow framework, a Microsoft Cognitive Toolkit framework, an Apache Singa framework, or an Apache MXNet framework.

Embodiments of the subject matter described in this specification can be implemented in a computing system that includes a back-end component, for example, as a data server, or that includes a middleware component, for example, an application server, or that includes a front-end component, for example, a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, for example, an HTML page, to a user device, for example, for purposes of displaying data to and receiving user input from a user interacting with the device, which acts as a client. Data generated at the user device, for example, a result of the user interaction, can be received at the server from the device.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A wearable particulate sensor device comprising:
a plurality of conductive gratings, each of the plurality of conductive gratings comprising a respective pore size of a plurality of different pore sizes;
a control unit in electrical communication with the plurality of conductive gratings; and
a housing aligning the plurality of conductive gratings with respect to an airflow path when the wearable particulate sensor device is affixed to a wearable device,
wherein a respective resistivity of one or more of the plurality of conductive gratings changes in response to a presence of a threshold concentration of a particulate in the airflow path.

2. The sensor device of claim 1, wherein, in response to the presence of the particulate in the airflow path, the respective resistivity of the one or more of the plurality of conductive gratings changes by a first amount, and
wherein, in response to a presence of a second, different particulate in the airflow path, the respective resistivity of the one or more of the plurality of conductive gratings changes by a second amount different from the first amount.

3. The sensor device of claim 1, wherein each of the plurality of conductive gratings comprise a conductive wire mesh including one or more of nanowires, carbon nanotubes, and bulk wires.

4. The sensor device of claim 1, wherein the plurality of conductive gratings comprise a SiN membrane.

5. The sensor device of claim 1, wherein the control unit is in data communication with one or more smart devices via a wireless data communication link.

6. The sensor device of claim 1, wherein the wearable device is a smart watch.

7. The sensor device of claim 6, wherein the housing is embedded in a watch band of the smart watch.

8. The sensor device of claim 1, wherein the plurality of conductive gratings comprise a first conductive grating having a first pore size of the plurality of different pore sizes and a second conductive grating having a second, different pore size of the plurality of different pore sizes.

9. The sensor device of claim 1, wherein the control unit is configured to detect the respective resistivity of one or more of the plurality of conductive gratings changing in response to a presence of a threshold concentration of a particulate in the airflow path.

10. A method for training a machine-learned particulate prediction model comprising:
generating training data for a plurality of known particulates in an environment comprising:
providing a plurality of conductive gratings, wherein each of the plurality of conductive gratings comprises a respective pore size of a plurality of different pore sizes;
providing, to the plurality of conductive gratings and incident on respective surfaces of the plurality of conductive gratings, a plurality of known concentrations of the plurality of known particulates, wherein, for each known concentration of the plurality of known concentrations of a known particulate of the plurality of known particulates:
providing, to the plurality of conductive gratings and incident on respective surfaces of the plurality of conductive gratings, the known concentration of the known particulate; and
collecting, by a data processing apparatus, data generated by the plurality of conductive gratings in response to the known concentration of the known particulate; and
providing, to the particulate prediction model, the training data.

11. The method of claim 10, wherein the data generated by the plurality of conductive gratings comprises a change in a respective resistivity of one or more of the plurality of conductive gratings in response to a presence of a threshold concentration of the known particulate.

12. The method of claim 10, further comprising:
receiving, by the machine-learned particulate prediction model, data generated by a conductive grating indicative of a detection of an unknown particulate by the conductive grating in an airflow path incident on the conductive grating;
generating, by the machine-learned particulate prediction model, a prediction comprising a size of the unknown particulate detected by the conductive grating; and
providing, by the machine-learned particulate prediction model, the prediction including the size of the unknown particulate detected by the conductive grating.

13. The method of claim 12, wherein receiving data generated by the conductive grating indicative of the detection of the unknown particulate comprises receiving an input voltage signal from the conductive grating.

14. The method of claim 12, wherein the prediction further comprises a prediction of a concentration of the unknown particulate detected by the conductive grating.

15. The method of claim 14, further comprising:
determining, based on the prediction including the size of the unknown particulate, an allergen in the airflow path;
generating an alert including information about the allergen; and
providing the alert to a user.

16. The method of claim 15, wherein the alert including information about the allergen further comprises information about a concentration of the allergen.

17. The method of claim 15, wherein determining the allergen in the airflow path comprises comparing the size of the unknown particulate to a lookup table of pollen sizes to identify the allergen.

18. The method of claim 15, wherein determining the allergen in the airflow path comprises:
providing, to a neural network, the prediction including the size of the unknown particulate; and
receiving, from the neural network, the allergen in the airflow path.

19. The method of claim 10, wherein generating training data for the plurality of known particulates in the environment further comprises:
providing, to the plurality of conductive gratings and incident on respective surfaces of the plurality of conductive gratings, and for each of the plurality of known concentrations of the plurality of known particulates, the known concentration of the known particulate over a range of time corresponding to respective changes in sensitivity of the plurality of conductive gratings over the range of time; and
collecting, by the data processing apparatus, data generated the plurality of conductive gratings in response to the known concentration of the known particulate over the range of time; and
providing, to a machine-learned particulate prediction model, the training data.

20. The method of claim 17, further comprising:
receiving, by the machine-learned particulate prediction model, data generated by a conductive grating of the plurality of conductive gratings indicative of a detection of a given particulate by the conductive grating;
generating, by the machine-learned particulate prediction model, a prediction of an estimated lifetime of the conductive grating; and
providing, by the machine-learned particulate prediction model, the prediction including the estimated lifetime of the conductive grating.
